(19) United States
(12) Patent Application Publication
(10) Pub. No.: US 2008/0230557 A1
(43) Pub. Date: Sep. 25, 2008

(54) BULK FEEDING SYSTEM AND METHOD

(75) Inventors: Richard T. Price, Lehi, UT (US); Byron D. Larson, South Jordan, UT (US)

Correspondence Address: DAVID R. MCKINNEY, P.C., P.O. BOX 1460, SANDY, UT, 84091, US

(73) Assignee: MULTI-FILL, Inc.

(21) Appl. No.: 12/050,818

(22) Filed: Mar. 18, 2008

Related U.S. Application Data
(63) Continuation-in-part of application No. 11/726,400, filed on Mar. 21, 2007.

(51) Int. Cl. G01F 11/00; B67D 5/40

(52) U.S. Cl. 222/1; 222/372

(57) ABSTRACT

A bulk product feeding system includes a product hopper, and a reciprocating ram, positioned in the bottom of the hopper. The hopper has substantially vertical sidewalls, and the ram has a width substantially equal to the width of the hopper. The hopper is configured to hold a bulk quantity of sticky or fragile product, and the sidewalls are spaced apart a distance sufficient to resist bridging of the product. The ram is configured to selectively reciprocate to controllably discharge product through the outlet. The bulk feeding system can include additional features such as a stepped ram, a flexible finger gate, and an oscillating finger gate.

### PRIORITY CLAIM

The present application is a continuation-in-part of U.S. non-provisional patent application Ser. No. 11/726,400, filed Mar. 21, 2007, entitled BULK FEEDING SYSTEM AND METHOD.

### BACKGROUND

1. Field of the Invention

The present invention relates generally to equipment for handling food products and other fragile bulk products.

2. Related Art

In food packaging operations, bulk products such as cooked noodles, rice, etc. are frequently transported from the cooking facilities to the packaging facilities via a large container (e.g. 300 liter “bucket”) and dumped into the inlet of a portioning and packaging machine. This machine divides the bulk product into individual portions and places the portions into packages. This sort of operation is widely used for packaging TV dinners and the like.

Many mechanical bulk product portioning and packaging machines cannot receive large quantities of the product all at once, especially where the product is sticky or fragile. This is because of the nature of the products and of bulk product transporting machines. Bulk product transport machines generally include a large tapered hopper into which the product is dumped, with a transport mechanism such as a conveyor or auger at the bottom, to which all product is directed, and which draws the product at some desired rate out of the hopper.

Unfortunately, sticky products tend to bridge across the narrow neck of the hopper, causing the auger or conveyor to “tunnel” through the bottom of the product, thus stopping the flow. This sort of condition requires constant worker attention, which increases the cost of packaging and handling the product. Augers and similar devices can also be damaging to fragile products, and can be dangerous to operators.

### SUMMARY

It has been recognized that it would be advantageous to develop a product dispensing system that can receive product in relatively large quantities at spaced apart intervals, and dispense the product at a much lower controlled rate.

It has also been recognized that it would be advantageous to have a product dispensing system that is resistant to bridging and clogging of product within a product hopper.

It has also been recognized that it would be advantageous to have a product dispensing system that is gentle to fragile products, such as food products.

In accordance with one embodiment thereof, the present invention provides a bulk product feeding system, including a product hopper, having a bottom, and a ram, positioned in the bottom of the hopper. The hopper has a front end, substantially vertical sidewalls defining a width, and an outlet located at the bottom of the front end. The hopper is configured to receive and hold a bulk quantity of sticky or fragile product, the sidewalls being spaced apart by a distance sufficient to resist bridging of the product. The ram has a width substantially equal to the width of the hopper, and is configured to selectively extend to push product out of the outlet, and to retract to allow product to drop down to the bottom of the hopper.

In accordance with another aspect thereof, the invention provides a product packaging system, including a bulk feeder, and a product measuring and dispensing apparatus. The bulk feeder includes a product hopper with a bottom, and a ram, positioned in the bottom of the hopper. The hopper includes a front end, substantially vertical sidewalls defining a width, and an outlet located at the bottom of the front end, configured to receive and hold a bulk quantity of sticky or fragile product. The sidewalls of the hopper are spaced apart a distance sufficient to resist bridging of the product. The ram has a width substantially equal to the width of the hopper, and is configured to selectively extend to push product out of the outlet, and to retract to allow product to drop down to the bottom of the hopper. The product measuring and dispensing apparatus includes an inlet, positioned to receive the product dispensed from the bulk feeder, and to dispense measured quantities of the product into containers.

In accordance with yet another aspect thereof, the invention provides a method for controllably dispensing a bulk product. The method includes the steps of placing a bulk quantity of the product into a hopper having substantially vertical sidewalls defining a width sufficient to resist bridging of the product, a bottom, a front end, and an outlet located the bottom at the front end, and dispensing a controlled quantity out of the outlet of the hopper with a reciproical ram positioned in the bottom of the hopper.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a top rear perspective view of one embodiment of a bulk feeding hopper with a reciprocal ram in accordance with the present disclosure;

FIG. 2 is a front perspective view of the bulk feeding hopper of FIG. 1;

FIG. 3 is a side, cross-sectional view of one embodiment of a bulk feeding system having a hopper and ram like that of FIG. 1, showing the ram in the retraction phase;

FIG. 4 is a side, cross-sectional view of the embodiment of FIG. 3, showing the ram in the extension phase;

FIG. 5 is an illustration of one embodiment of a product packaging system incorporating a bulk feeding system in accordance with the present disclosure;

FIG. 6 is an illustration of another embodiment of a product packaging system incorporating a bulk feeding system in accordance with the present disclosure;

FIG. 7 is a side, cross-sectional view of an embodiment of a bulk feeding system like that of FIG. 3, having directionally pivoting product-loosening fingers attached to the ram, showing the ram in the retraction phase;

FIG. 8 is a side, cross-sectional view of the embodiment of FIG. 7, showing the ram in the extension phase;

FIG. 9 is a side, cross-sectional view of an alternative embodiment of a bulk feeding system in accordance with the present disclosure;

FIG. 10 is a side, cross-sectional view of an embodiment of a bulk feeding system having a stepped ram and other features in accordance with the present disclosure;

FIG. 11 is a front, perspective view of the bulk feeding hopper of FIG. 10, showing the finger gate;

FIG. 12 is a top rear, partially cut-away perspective view of an embodiment of a bulk feeding hopper having two stepped rams operating in a common direction;

FIG. 13 is a top rear, partially cut-away perspective view of an embodiment of a bulk feeding hopper having two stepped rams operating in opposing directions;

FIG. 14 is a side, cross-sectional view of an embodiment of a bulk feeding system having an oscillating finger gate; and

FIG. 15 is a front view of the bulk feeding hopper of FIG. 14.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

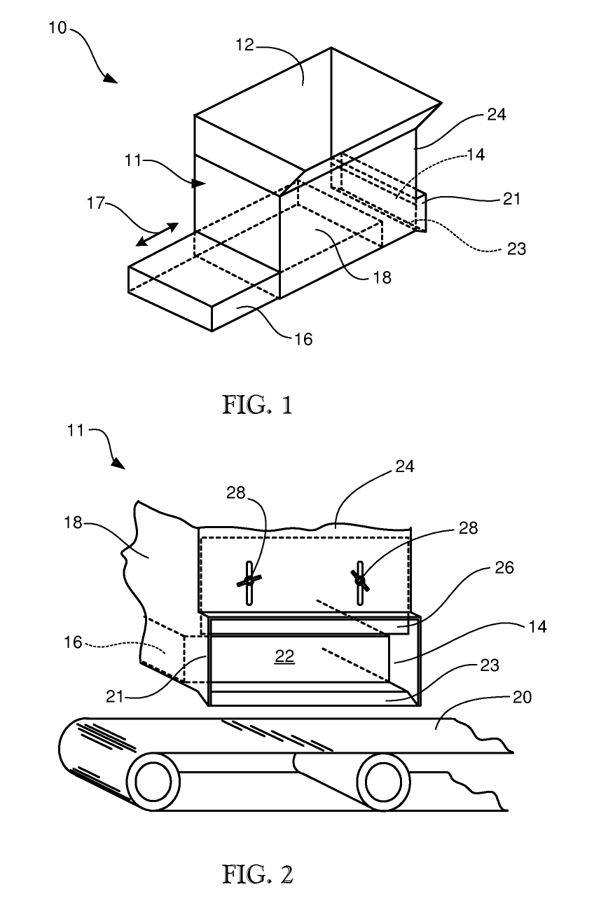

The inventors have developed a bulk feeding system that allows sticky or fragile products, such as food products, to be loaded in bulk into a feed hopper for a product packaging system, and which avoids or reduces some problems, such as tunneling and damage to the product, that are common with augers or conveyors and other bulk product transport devices. One embodiment of a bulk feeding system 10 is shown in FIGS. 1 and 2. The system generally includes a bulk feed hopper 11 having an inlet 12, an outlet opening 14, and a reciprocating ram 16 that slides back and forth in the bottom of the hopper, as indicated by arrow 17. The hopper has vertical sidewalls 18 and is made wide enough so that the product cannot bridge between the sides. The ram is as wide as the hopper, and has a cross-sectional shape that is similar to the size and shape of the outlet opening. The size and shape of the hopper, the ram, and other components of the bulk feeding system can vary. In one embodiment, the hopper is approximately 4 ft high, 2 ft long and 1.5 ft wide, and holds a volume of about 90 gallons. To effectively prevent product from bridging in the bottom of the hopper, the width of the hopper can range from as small as about 6 inches wide, though more practically about 1 foot wide to about 4 feet wide or more.

In use, bulk product 30 is dumped into the inlet 12 of the hopper 11 in large batches, and is pushed out of the outlet 14 opening by the ram 16 at a controlled rate. When the ram retracts (i.e. pulls partially out of the hopper), the bulk product falls down into the bottom of the hopper. When the ram is extended forward, product is pushed out of the outlet. The top surface of the ram is flat and smooth so that the ram can slide beneath the product in the hopper during its extension phase, and so that product cannot become trapped behind the ram during the retraction phase. The ram can vary from about ½ inch high to about 6 inches high, depending upon the product flow and desired feed rate. Where food products are to be dispensed, the bulk feeder (e.g. the hopper, ram, etc.) can be made of food grade acceptable stainless steels and plastics.

A view of the forward end of the hopper 11 and ram 16 is shown in FIG. 2. The outlet 14 of the hopper can be located adjacent to a product conveyor 20 onto which product falls as it is discharged from the hopper. A projecting shroud 21 can be provided around the sides and top of the outlet, and this can interconnect with a ramp 23 that extends downwardly from the bottom edge of the outlet toward the conveyor, to guide the product as it discharges. As shown in FIG. 2, this conveyor can be oriented substantially perpendicular to the direction of motion of the ram, but this is not required.

The outlet 14 can include an adjustable choke plate 26 that can be raised or lowered within the outlet opening and secured at a desired elevation (e.g. via wing nuts 28) to allow the size of the outlet opening to be adjusted. The outlet opening can vary from approximately the same height as the ram 16, up to about 6 times the height of the ram. In addition, a given bulk feeding system can be provided with multiple rams of different heights, allowing a user to interchange the ram at will to use a different ram for a different product, with the height of the outlet adjusted accordingly. The size of the outlet opening and how much clearance is provided around the forward face of the ram at maximum extension are factors that can vary depending upon the nature of the product being discharged. Typically, the outlet of the hopper is slightly higher than the ram, so that if the ram is fully extended (i.e. extended so that the forward face 22 of the ram becomes substantially aligned with the forward wall 24 of the hopper) any product that might be hanging in the outlet opening will not be cut off.

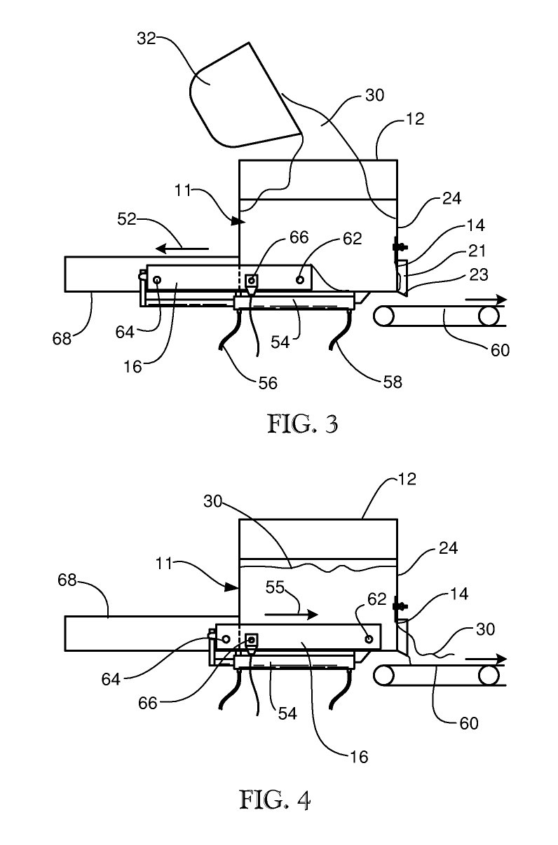

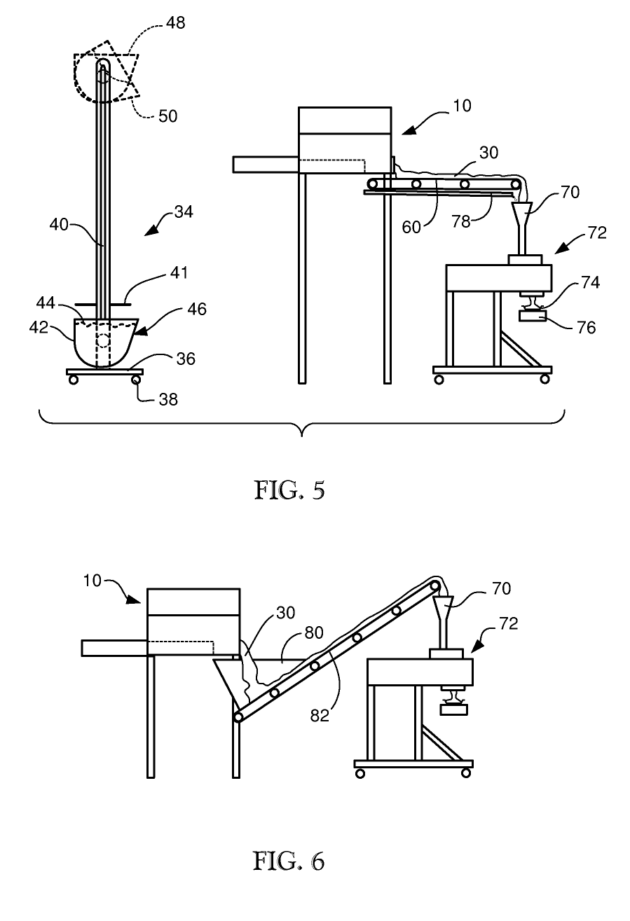

Side, cross-sectional views of one embodiment of a bulk feeding system 10 having a hopper and ram like that of FIG. 1 are provided in FIGS. 3 and 4. In typical use, a relatively large quantity of product 30 is dumped into the inlet 12 of the hopper 11 from come sort of conveyance container 32. The conveyance container can be part of a bin hoist, for example. Bin hoists are frequently used in the food packaging industry for transporting batches of food product from a kitchen to the product packaging area. One type of bin hoist 34 is shown in FIG. 5. The bin hoist includes a base 36 having wheels or casters 38, with a vertical mast 40 attached to the base. A handle 41 is attached to the mast to allow a user to roll the hoist to a desired location. A bin 42 for containing bulk product 44 (shown in dashed lines) is attached to the mast, and can be moved from a lower position, shown at 46, to a raised position (shown in dashed lines at 48). The bin is usually held at the lower position when it is desired to move the bin hoist to another location. When at the desired location, the bin is hoisted up the mast (e.g. via a hand crank or via a power winch mechanism) to the raised position, at which the bin can be rotated, as shown at 50, to allow the user to dump the product.

Referring back to FIG. 3, when the product 30 is dumped into the inlet 12 of the hopper 10, the ram 16 is initially retracted, in the direction of arrow 52, to allow the product to fall to the bottom of the hopper. The ram can be powered in a variety of ways. In the embodiment depicted in FIGS. 3 and 4, the ram is powered by a bi-directional pneumatic cylinder 54 that can cause the ram to retract in the direction of arrow 52 in FIG. 3, or extend in the direction of arrow 55 in FIG. 4. When the ram is retracted, product falls to the bottom of the hopper, as shown in FIG. 3. When the ram extends, product is forced out of the outlet 14 and onto a conveyor 60 or other product receiving device. This allows the product to be loaded into the hopper in large batches (which may not be uniform in volume), and discharged from the bulk feeding system at a lower, controlled rate.

Compressed air is provided to the pneumatic cylinder via air lines 56, 58. A system controller (not shown) can control the compressed air that is provided to the pneumatic cylinder (and control valves, etc.) to allow the direction, speed, and other aspects of the motion of the ram 16 to be very accurately controlled. For example, the ram can be caused to extend or retract with a pulsatile motion, having very long or very short dwell times between pulses. Pulsatile motion can be desirable for inducing vibration into the product to prevent sticking, encourage loosening, etc. A wide variety of other motions can also be provided.

The system shown in FIGS. 3 and 4 includes a mechanism for sensing the motion of the ram 16. Such a system can be configured in many ways. In this system the side walls of the ram include holes 62 near the forward end of the ram, and holes 64 near the rear end of the ram. An optical sensor 66 is attached to one side wall of the hopper, and is aimed at a corresponding target or reflector (not shown) positioned on the inside of the opposite wall of the hopper. When the ram retracts to a position in which the optical sensor 66 is aligned with the forward holes 62, a circuit will be completed in the sensor, which will send a signal to the controller that the ram is fully retracted. Conversely, when the ram extends to a position in which the optical sensor is aligned with the rearward holes 64, the same circuit will also be completed in the sensor, and, because the direction of motion of the ram is known, this will send a signal to the controller that the ram is fully extended. This sensing system thus detects the extreme positions of the ram, allowing the direction of the ram to be reversed at the appropriate time. It is to be understood, however, that other and more sophisticated sensing systems can be used to detect the position and motion of the ram.

A ram cover 68 can also be provided to encase the ram and cover at least some of the moving parts associated with it. This cover can also help to protect the ram from damage and from contact with foreign materials. For example, since the ram comes into direct contact with the product that is dispensed from the hopper 10, it can be desirable to protect the ram from dirt or debris that might contaminate a food product.

Two exemplary installations of bulk feeding systems 10 are shown in FIGS. 5 and 6. In FIG. 6, the bulk feeding system is elevated and positioned to discharge product onto a horizontal conveyor 60. This conveyor in turn feeds the product into an inlet 70 of a product portioning machine 72 that dispenses measured portions of product into containers 74 on a conveyor 76. Alternatively, the conveyor could transport the product to a multipathway product distribution system that directs the product to multiple product portioning machines. The use of a horizontal conveyor can be desirable where the product includes liquid that it is desirable to retain. For example, some food products include sauce or broth that can tend to drip away during packaging. With the horizontal conveyor 60 shown in FIG. 5, liquids are generally retained. Additionally, a drip trough 78 can be positioned below the conveyor to catch liquids that might drip from the conveyor. The drip trough can be sloped to cause the liquids to drain into the inlet of the product portioning machine.

As an alternative to the horizontal conveyor 60 shown in FIG. 5, a bulk feeding system configured as described herein can be positioned to discharge product into an inlet hopper 80 of a sloped product conveyor 82 that feeds into an inlet 70 of a product portioning machine 72. With this configuration the bulk feeding machine is not required to be positioned quite as high. However, in both cases a bin hoist is likely to be used to lift and dump the product into the inlet of the bulk feeding system.

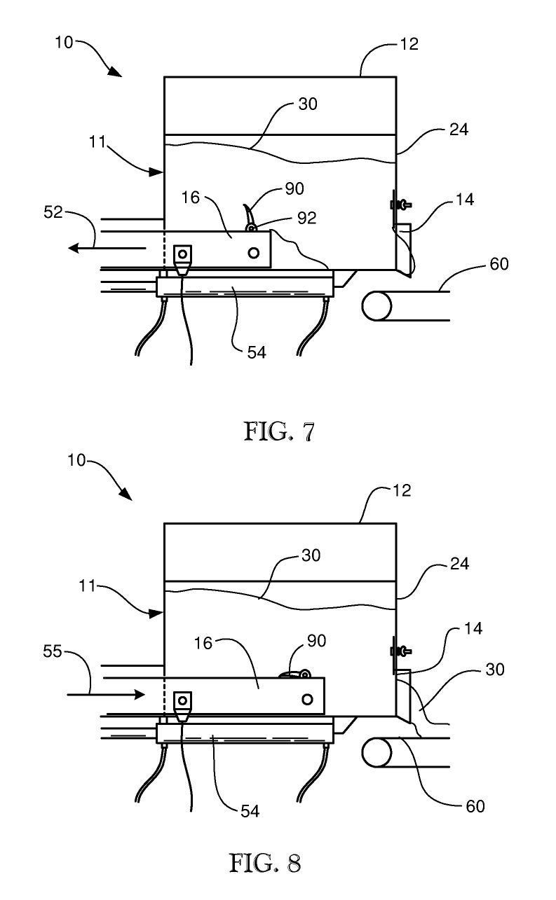

The bulk feeding system 10 can also include a product separator device that helps to break up and loosen product as the ram retracts. Some bulk products, especially sticky food products such as cooked noodles, rice, etc., can tend to stick or clump together, especially when located near the bottom of a hopper filled with the product. The inventors have found that the motion of the bulk feeding ram can be used to help break up and loosen the product so that it will be easier to discharge from the bulk feeding system. One embodiment of a product separator device is shown in FIGS. 7 and 8. In this embodiment, a rake 90 is pivotally attached to the forward end of the ram 16 at a pivot mount 92. The view provided in FIGS. 7 and 8 is a side view, and does not show the teeth of the rake. However, it is to be appreciated that the rake includes a plurality of teeth or tines that are relatively rigid and are separated from each other by some uniform spacing. The length and spacing of the rake tines can vary depending upon the product that is to be separated. The teeth or tines can be relatively blunt, so as to be gentle to the product, though the degree of bluntness or sharpness can also vary depending upon the product.

The pivot mount 92 can be provided with a stop (not shown) so that the rake 90 will pivot between an approximately upright position, shown in FIG. 7, with the teeth of the rake pointed upwardly, and a substantially horizontal position, lying substantially flat against the top of the ram, as shown in FIG. 8. With this configuration, rearward motion of the ram 16, in the direction of arrow 52, during the retraction phase shown in FIG. 7 will cause the rake to stand up and rake through the underside of the product. This will help loosen the product and allow it to more readily fall down into the bottom of the hopper 11. However, during extension of the ram, as shown in FIG. 8, the rake will naturally drop down against the top of the ram when the ram moves in the direction of arrow 55, and will not rake through the product.

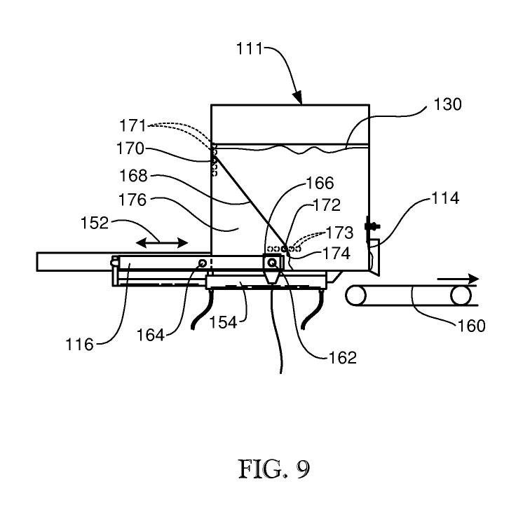

A cross-sectional view of another embodiment of a bulk feeding system is shown in FIG. 9. In this embodiment the proportions of the hopper 111 and ram 116 are varied, such that the hopper is taller and the ram is shorter (thinner) than other embodiments depicted previously. The ram reciprocates in the direction of arrow 152 under the power of the actuator 154 (e.g. a pneumatic cylinder) to push the product 130 through the outlet 114 and onto the conveyor 160. In this embodiment, the hopper is provided with an adjustable baffle 168 that slopes down toward the outlet. The baffle is supported within the hopper by an upper support pin or bolt 170 and a lower support pin or bolt 172, and has a lower edge 174 that defines a rear opening through which the ram extends and retracts as it reciprocates. Because of the position of the baffle, there is a space 176 behind the baffle into which product does not enter when dumped into the hopper. The height of the rear opening can be just slightly higher than the ram, in order to reduce any quantity of product that might be drawn into the space behind the baffle by the reciprocating motion of the ram. The configuration of the baffle reduces the amount of product that presses upon the top of the ram, and thus reduces the pressure that is imposed upon the ram, making it easier to move the ram. This can be desirable with some products. While the baffle also tends to reduce the useable volume of the hopper, this can be taken into account when designing a hopper for a given type of product.

The upper and lower support pins 170, 172 can be selectively positionable within a series of mounting holes 171, 173, respectively. This allows the positions of the support pins to be adjusted so that the position and slope of the baffle can vary. The desired position and slope of the baffle within the hopper 111 can vary depending upon the nature of the product that is to be dispensed with the bulk feeding system. It will be apparent that other methods for adjustably attaching a baffle or comparable device within the hopper can be used, as can other systems for selectively adjusting the internal geometry and volume of the hopper. It should also be noted that a fixed baffle can be disposed in the hopper, as an alternative to an adjustable one. A fixed baffle can have the effect of structurally stiffening the hopper, though it does not have the flexibility of use of the adjustable baffle.

In the embodiment depicted in FIG. 9, the stroke length of the ram 116 will be shorter than the length of the hopper 111. Consequently, the ram can be provided with sensor holes 162 and 164 that are closer together than in other embodiments, with an optical sensor device 166 positioned to detect when the ram is fully extended and when it is retracted past the rear opening below the baffle 168. It will be apparent that the ram can be provided with multiple sensor holes that can be covered or left open, as desired, to allow the stroke length of the ram to be adjusted among a range of lengths.

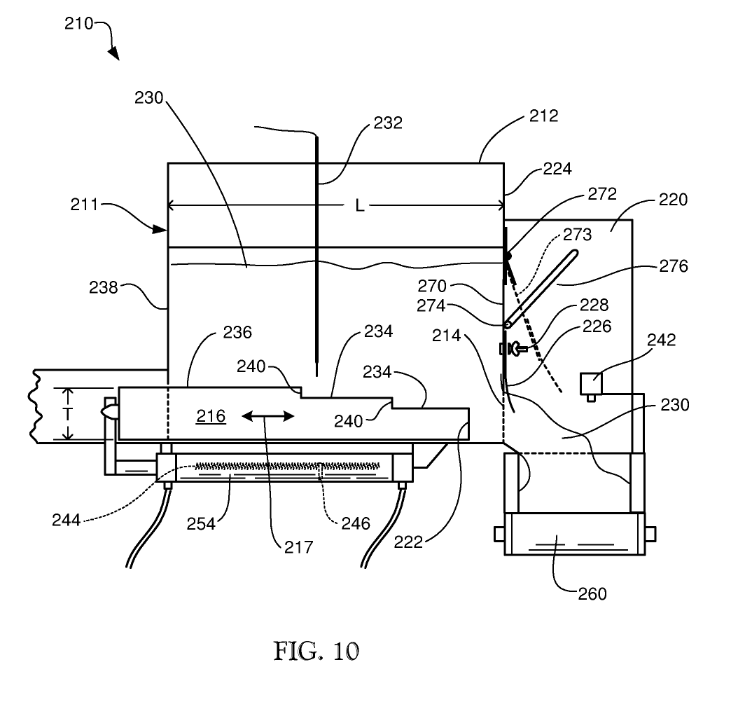

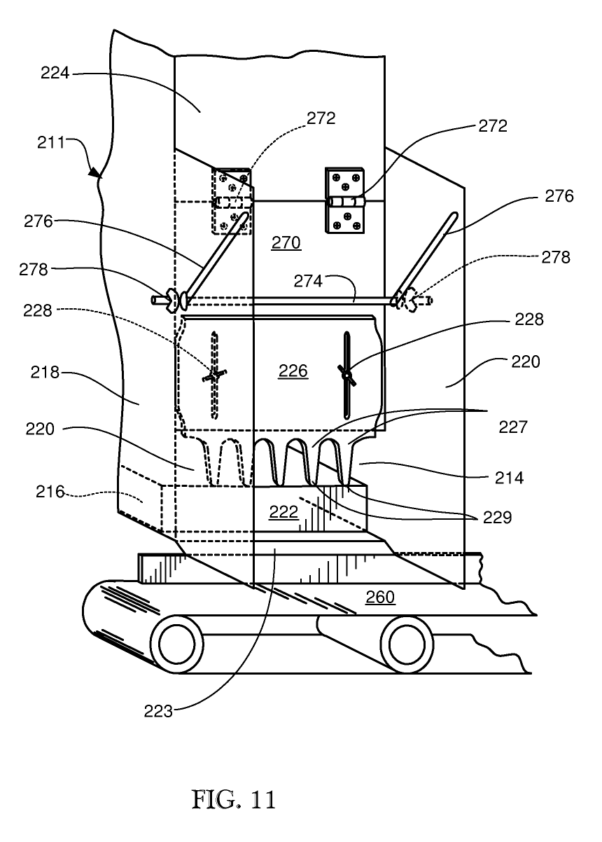

Shown in FIGS. 10 and 11 are a side, cross-sectional view and front view of another embodiment of a bulk feeding system 210 having additional features. As with other embodiments described above, this bulk feeding system includes a bulk feed hopper 211 having an inlet 212, an outlet opening 214, and a reciprocating ram 216 that slides back and forth in the bottom of the hopper, as indicated by arrow 217. The hopper has vertical sidewalls 218 and is wide enough to substantially prevent the product 230 from bridging between the sidewalls. The size and shape of the hopper, the ram, and other components of the bulk feeding system can vary, as discussed above.

As described above, bulk product 230 is dumped into the inlet 212 of the hopper 211 in large batches, and is then pushed out of the outlet 214 opening by the ram 216 at a controlled rate. When the ram retracts (i.e. moves to the left in FIG. 10), the bulk product sinks down toward the bottom of the hopper. When the ram is extended forward (to the right in FIG. 10), product is pushed out of the outlet. The bulk feeding system can be located adjacent to a product conveyor 260, or other product receiving device (e.g. a conveyor or product filling machine like those shown in FIGS. 5 and 6) onto which product falls as it is discharged from the hopper. This allows the product to be loaded into the hopper in large batches (which may not be uniform in volume), and discharged from the bulk feeding system at a lower, controlled rate.

The ram 216 is actuated by a pneumatic cylinder 254, which can be provided with compressed air and controlled in the same manner as other embodiments described above. The bulk feeding system can also include a depth sensor 232 that extends downwardly into the hopper 211 to detect when the hopper is at or near empty. This sensor can be a conductivity sensor that measures the electrical conductivity of the product whenever the product is in contact with the sensor. The controller for the bulk feeding system can be programmed such that, when a sudden drop in conductivity occurs, the system recognizes this as indicative of a product out condition. In such a case, the system can be programmed to stop moving the ram 216 to dispense product from the bulk feeder, and send an indication to a worker to take appropriate action.

One advantageous feature of the bulk feeding system embodiment of FIG. 10 is that the top surface of the ram 216 is stepped, with a series of steps 234 leading downward from the upper rear surface 236 of the ram to the lower forward end or nose 222 of the ram. These steps are flat and smooth so that the ram can slide beneath the product in the hopper 211 during its extension and retraction phases. The maximum stroke length of the ram can be selected to be no longer than the top rear surface of the ram, and this length can be about half the length L of the hopper. Having the maximum stroke no longer than the top rear surface of the ram ensures that the body of the ram will always substantially fill the opening in the back wall 238 of the hopper to prevent product from exiting through the ram opening.

The inventors have found that a stepped ram 216 like that shown in FIG. 10 takes less energy to move than an unstepped ram, it moves the product better, and it also eliminates the need for a sloped baffle like that shown in FIG. 9. As the ram retracts, the back wall 238 of the hopper 211 pushes product off of the top rear surface 236 of the ram and toward the lower steps 234. This action helps clear product out of the hopper because the vertical step surfaces 240 will tend to push product toward the outlet 214.

The height, length and number of the steps 234 on the ram 216 can vary. In the embodiment shown in FIG. 10, the ram includes two steps, but a single step or more than two steps can also be used. In the embodiment that is shown, the total combined length of the steps is about half the total length of the ram (i.e. about half the length L of the hopper), but different lengths can be used. The total combined height of the steps can be about half the total height or thickness T of the ram, though other proportions for the step heights can also be used. The inventors have found that shorter steps can allow shorter strokes, which can allow quicker response times with shorter cycle times between discharges. In one embodiment, the inventors have used a ram having a total length of about 25″ and height T of about 3″, with two steps 234 that are each about 8″ long and 1″ high. These dimensions result in a ram having a nose 222 that is about 1″ high. It is also to be appreciated that a given bulk feeding system can be provided with multiple stepped rams of different shapes and configurations, allowing a user to interchange the ram at will to use a different ram for a different product, etc.

The bulk feeding system 210 shown in FIGS. 10 and 11 includes some other advantageous features. As shown in FIG. 10, a product level sensor 242 can be positioned above the conveyor 260. This sensor can be an optical proximity detector that is positioned to detect the level of product 230 that has been dispensed onto the conveyor. This sensor can be interconnected to the bulk feeding system controller to provide real time feedback for controlling the motion of the ram 216. For example, when product exiting the outlet 214 of the hopper 211 rises to a certain level, it will trip this sensor, which will send a signal to the controller to slow or even stop the ram. This allows very accurate control of the rate at which product is dispensed from the hopper.

The ram 216 can be moved and controlled in many different ways, as discussed above. In addition to the control methods described above, one other control approach that the inventors have used is to provide the air cylinder 254 that powers the ram with a variable resistor. Those of skill in the art will recognize that variable resistors can take many different forms. One embodiment that has been used by the inventors is a variable resistor comprising an elongate wire coil 244, disposed inside the air cylinder, with an electrical contact 246, also inside the cylinder and in sliding contact with the coil. The contact moves back and forth with the piston (not shown) that is inside the cylinder. This variable resistor provides a different resistance to electrical current depending upon the relative position of the contact along the coil, which varies with the relative extension or retraction of the cylinder 254. This allows the control system to accurately detect the position of the cylinder (and hence of the ram) at all times. This careful positional tracking can be used to provide highly accurate motion control. For example, the inventors have found that relatively short stroke lengths (e.g. about 6″) of the ram tend to give a greater product output rate since less discharge time is lost in retracting the ram. Consequently, feedback from both the product level sensor 242 and the variable resistor 244 of the ram actuator allow the system to cause the ram to change speed and direction in a variety of ways to either increase or decrease the product output as desired.

Another aspect of adjustability of motion of the ram 216 relates to the characteristics of the product 230 that is being dispensed. The inventors have found that various products have different compression rates. That is, after the ram has been retracted and then first begins to extend, the product 230 can compress some amount before actually beginning to discharge from the outlet 214 of the hopper 211. The amount of compression depends on the characteristics of the product, and is also proportional to the amount of product that is ahead of the nose 222 of the ram, which, in turn, depends upon the stroke length of the ram's motion. In order to provide relatively continuous discharge, the inventors have found that it is useful to preload the product at the beginning of each forward stroke of the ram. That is, whenever the ram retracts to begin a new stroke, the system can then automatically move the ram forward a preload distance, at full speed, to account for the product compression. After the product has been preloaded the system can then control the ram using feedback from the product level sensor 242 as discussed above. For example, products like rice and macaroni exhibit relatively little compression, and therefore require little or no preloading (e.g. less than 1″ for hopper that is about 24″ long). On the other hand, products like 10″ cooked noodles (e.g. spaghetti or fettuccini) exhibit substantial compression, and can require preloading of about 4″ in a 24″ hopper. It is to be understood that the amount of preloading depends on the product characteristics (e.g. cooked, uncooked, wet, dry) and can also vary for a given product over time.

Provided in FIG. 11 is a view of the forward end of the hopper 211, showing the nose 222 of the ram 216 and the conveyor 260. A projecting ramp 223 and sidewalls 220 can be provided around the sides and bottom of the outlet 214 to guide the product onto the conveyor as it discharges. As shown in FIGS. 10 and 11, the conveyor can be oriented substantially perpendicular to the direction of motion of the ram, but other orientations can also be used, some of which are shown in other figures herein. The front wall 224 of the hopper can include a pivoting gate 270 that extends up from the top of the outlet 214 and is pivotally attached at its top to the front wall with hinges 272. The pivoting gate can be of substantially rigid material, such as the same or comparable material to the hopper (e.g. stainless steel). The lower edge of the pivoting gate defines a top edge of the outlet opening. As indicated in dashed lines at 273 in FIG. 10, the pivoting gate can swing forwardly away from the front wall of the hopper, in order to increase the effective size of the outlet.

A transverse stop bar 274 can be positioned in front of the pivoting gate 270 to limit its swing. This stop bar can extend between a pair of angled slots 276 that are provided in the sidewalls 220 that surround the outlet 214. The stop bar can be tightened in any selected position along the angled slots using a pair of wing nuts 278 that are disposed on the outer ends of the stop bar. With this configuration, the pivoting gate can rotate between the sidewalls 220 under the force of the discharging product from a substantially vertical position (i.e. substantially coplanar with the front wall 224 of the hopper) to a position that is rotated almost 90° relative to the front wall, or any position in between, depending upon the position of the stop bar. This configuration greatly increases the degree to which the outlet of the hopper can be opened. Opening up the outlet can be particularly desirable when discharging spaghetti or other products that tend to clump together in a mass, and resist discharge through the outlet.

In this embodiment, a flexible finger gate 226 is attached to the lower end of the pivoting gate 270 in a position partially blocking the outlet 214. The finger gate comprises a flat sheet of flexible material that is attachable to the pivoting gate, and has a plurality of downwardly extending fingers 227 that taper toward their lower ends 229. The shape and number of fingers can vary. The finger gate can be of a wide variety of flexible polymer materials and can be about ¼″ thick.

The height of the flexible finger gate 226 is adjustable via the wing nuts 228, so that its position can be raised or lowered relative to the lower end of the pivoting gate 270 of the hopper, and relative to the height of the nose 222 of the ram 216. This allows the effective size of the outlet opening and its resistance to passage of product to be adjusted. As shown in FIG. 11, the bottom extremities 229 of the fingers can be positioned to be at about the same height as the top of the nose 222 of the ram, though this is only one possible position. The size of the outlet opening and the height of the finger gate are factors that can be adjusted depending upon the nature of the product being discharged. Additionally, the most effective position for the finger gate can depend upon the angle to which the pivoting gate is rotated. Where the pivoting gate is allowed to rotate a relatively large amount, it can be desirable to extend the finger gate lower relative to the bottom of the pivoting gate because of the more oblique angle of the finger gate relative to the direction of discharge of the product.

Because of its flexibility and strength, the finger gate 226 can hold back product 230 at the outlet 214 of the hopper to a certain extent, thus moderating the discharge rate. The fingers 227 also help to loosen product as it is being discharged from the outlet. This helps to prevent individual particles like noodles, rice, etc. from sticking together and being discharged in large slugs. Additionally, because of its flexibility and its geometry, the finger gate helps to minimize potential damage to fragile products (i.e. the possibility of the ram cutting products with a scissors action upon reaching the fully extended position) and reduces the potential safety hazard to the fingers or hands of workers.

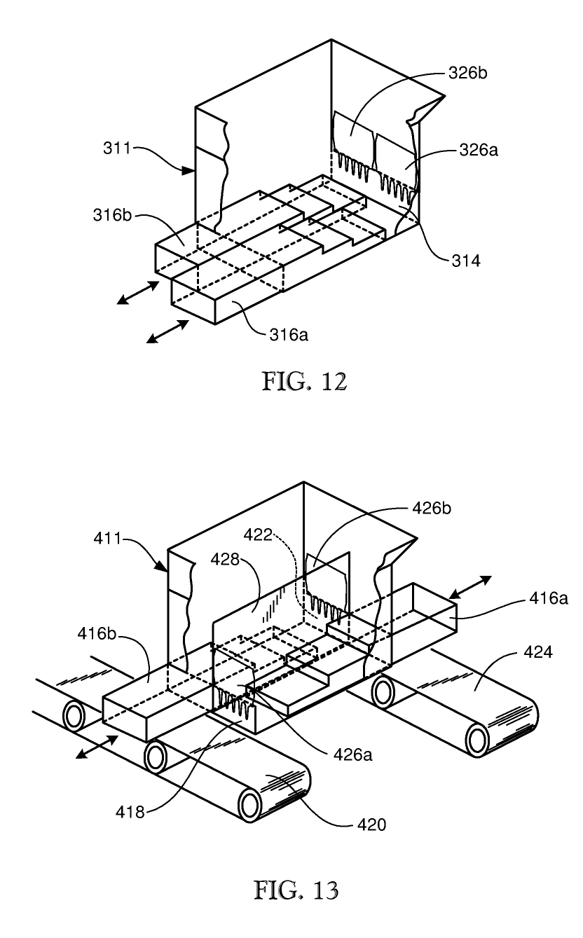

The stepped ram 216 shown in FIG. 10 can be used in various different bulk feeding hopper configurations. For example, shown in FIG. 12 is a top rear perspective view of an embodiment of a bulk feeding hopper 311 having two stepped rams 316a, b operating in a common direction. The inventors have found that a pair of rams operating side-by-side helps to agitate the product, and can thus provide more efficient discharge. The inventors have also found that separate finger gates 326a, b aligned with each ram help to modulate the product flow, even when a single outlet opening 314 is used.

Another dual ram embodiment is shown in FIG. 13. In this embodiment the bulk feeding system has two stepped rams 416a, b positioned in a single hopper 411, but discharging product in opposing directions. The hopper has a first outlet 418 on one side of the hopper, positioned adjacent to a first conveyor belt 420, and a second outlet 422 on the opposite side of the hopper, positioned adjacent to a second conveyor belt 424. Each outlet can have a flexible finger gate 426 as described above. The interior of the hopper can include a longitudinal baffle 428 in the bottom that separates the two stepped rams 416 and prevents product from being damaged by the opposing motion of the rams, and also helps separate the respective product flow paths. This baffle can extend upward to a level like that shown in the figure, leaving the upper portion of the interior of the hopper open, so that bulk product that is dumped into the hopper can be discharged from both outlets. This configuration allows one bulk feeding system to feed two separate product streams. A longitudinal baffle like that shown in FIG. 13 can also be included between the side-by-side rams in the embodiment of FIG. 12, if desired.

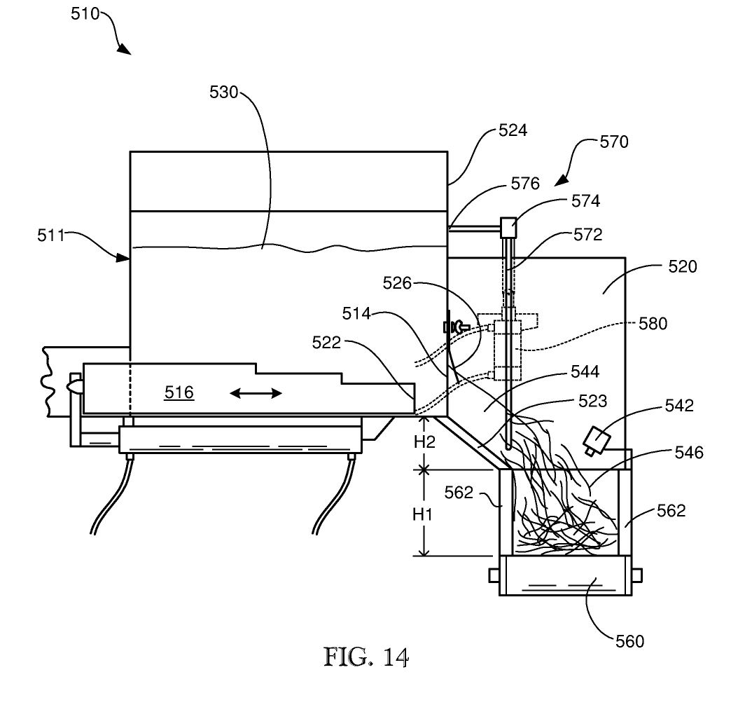

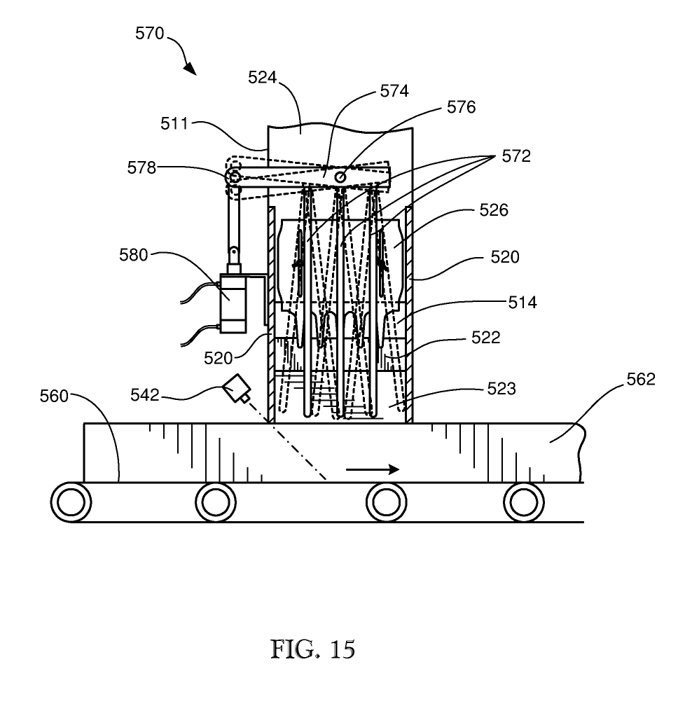

Another feature that can be advantageous for a bulk feeding system in accordance with the present disclosure is shown in FIGS. 14 and 15. Long, sticky products, such as cooked spaghetti or fettuccini noodles, are particularly difficult to handle in bulk quantites. The long noodles tend to stick together and tangle into unwieldy masses. Because of this tendency, long sticky products are typically handled by human workers, rather than by machine. Advantageously, the bulk feeding system shown herein can effectively handle bulk quantities of long, sticky product.

Shown in FIG. 14 is a side, cross-sectional view of an embodiment of a bulk feeding system 500 that is similar to that shown in FIG. 10, and a front view of the same is shown in FIG. 15. This system includes a hopper 511, a stepped ram 516, and other features like those discussed above. For example, this embodiment includes a flexible finger gate 526, which helps to loosen and separate the long sticky product, and includes a product level sensor 542 positioned above the conveyor 560 to provide feedback for operation of the ram. While the embodiment of FIGS. 14 and 15 is not depicted as having a pivoting gate, like that shown in FIGS. 10 and 11, it is to be understood that this embodiment can include such to allow the size of the outlet to be increased if desired. The inventors have also found that for long sticky product, a vertical drop distance is helpful for separating the product. Accordingly, an outlet ramp 523 slopes downward between the outlet 514 and the sidewall 562 of the conveyor 560, and the hopper is raised so that the outlet end of the ramp is a distance H1 above the output conveyor. With this configuration, the product has a significant vertical drop after leaving the ramp. Comparison of FIG. 14 with FIG. 10 helps make this vertical drop more apparent. The inventors used a ramp having about a 45° downward angle and a ramp height H2 of about 6″-12″, in combination with a vertical drop H1 of about 6″-12″ to the conveyor surface. These dimensions have been found to be helpful for separating cooked spaghetti noodles. It will be apparent that different dimensions and configurations of the outlet drop-off can also be used.

Advantageously, the embodiment shown in FIGS. 14 and 15 also includes an oscillating finger gate system 570 that effectively agitates and separates the long sticky product as it is discharged from the outlet of the hopper. The oscillating finger gate comprises a group of elongate needles or fingers 572 that are attached to a pivoting bar 574 that is positioned above the outlet 514 of the hopper 511. The pivoting bar is attached to the front 524 of the hopper at a pivot point 576, and is attached at a lever end 578 to an actuator 580, such as a pneumatic cylinder. The inventors have used ⅜″ diameter stainless steel rods for the fingers 572, though other materials and different sizes can also be used. While FIG. 15 shows three rods or fingers, the oscillating finger gate can have more or less than three rods. The rods or fingers extend downwardly in front of the outlet, and intercept the product 530 after it has been pushed through the outlet. The motion of the fingers agitates the product and thereby helps individual product pieces to separate from each other. As shown in the figures, the rods extend down almost to the surface of the ramp 523, and at a position just before the vertical drop off at the lower end of the ramp. Advantageously, the space between the oscillating finger gate and the front wall 524 of the hopper provides a space within which a pivoting gate (like the pivoting gate 270 in FIG. 10) can be opened, if such is included.

When the bulk feeding system is operating, the finger gate actuator 580 causes the steel rods 572 of the oscillating finger gate 570 to move back and forth in front of the hopper outlet 514, as illustrated in dashed lines in FIG. 15. Because of their shape and position, the oscillating rods shake the long sticky product to help it separate during the subsequent vertical drop. With sticky products, higher sidewalls 562 can be desirable on either side of the conveyor 560, as shown in FIG. 14. Additionally, because of the action of the oscillating finger gate, extended outlet sidewalls 520 can also be desirable to help direct individual pieces of product toward the conveyor.

The speed of oscillation of the oscillating finger gate 570 can vary depending on the nature of the product. It will be apparent that the length, weight, and other characteristics of the product pieces will influence the oscillation frequency that will effectively separate the product without causing undesirable effects. For cooked spaghetti noodles, the inventors have used an oscillation speed in the range of about 2-4 Hz. This action helps transform the product from moving as a large mass, as shown at 544 in FIG. 14, to being in more separate individual strands, as shown at 546. This action helps to both regulate and smooth out the flow rate of the material from the hopper onto the conveyor, and also helps improve the quality of the product by reducing the prevalence of undesirable clumps.

The invention thus provides a system that dispenses bulk products that may be sticky and/or fragile (e.g. not suitable for auger or direct conveyor withdrawl), and also allows the input of large quantities, while dispensing small quantities at a controlled rate. In various embodiments produced and tested by the inventors, the feeder can deliver product at a rate of more than 1,000 gallons per hour or 4,000 lbs. per hour, depending upon the nature of the product. The configuration of the hopper and ram prevents bridging and sticking of the product, thus allowing large quantities to be placed into the hopper while not requiring worker attention to prevent clogs, etc. Additionally, controlling the rate of extension of the ram allows control of the rate of dispensing of the product out of the bulk feeding system.

It is to be understood that the various elements of the bulk feeding system disclosed herein can be mixed and matched in many combinations not specifically shown in the figures. For example, the flexible finger gate can be associated with embodiments that do not have a stepped ram or a pivoting gate on the front of the hopper. Likewise, the oscillating finger gate can be associated with embodiments that do not have a stepped ram or a flexible finger gate. Many other combinations are also possible, and the present disclosure is intended to cover such.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A bulk product feeding system, comprising:
a product hopper, having a bottom, a front side, substantially vertical sidewalls defining a width, and a first outlet located at the bottom of the front side, the hopper being configured to receive and hold a bulk quantity of sticky or fragile product, the sidewalls being spaced apart by a distance sufficient to resist bridging of the product; and
a stepped ram, having a front end and at least one step descending toward the front end, positioned in the bottom of the hopper and having a width substantially equal to the width of the hopper, configured to reciprocate to controllably discharge product through the first outlet.

2. A bulk product feeding system in accordance with claim 1, wherein the ram has a dynamically adjustable stroke length, with a maximum stroke length that is about half a length of the product hopper, and wherein the steps of the ram have a combined length equal to about half the length of the hopper.

3. A bulk product feeding system in accordance with claim 1, further comprising a flexible finger gate, disposed adjacent to the first outlet, having flexible fingers that downwardly extend into at least a portion of the first outlet, to resist flow of bulk product therethrough.

4. A bulk product feeding system in accordance with claim 3, further comprising a pivoting gate, pivotally attached to the front side of the hopper and defining a top of the outlet, the flexible finger gate being attached at a lower end of the pivoting gate.

5. A bulk product feeding system in accordance with claim 1, further comprising two stepped rams, positioned side-by-side in the bottom of the hopper and configured to be independently reciprocally moveable therein, the two rams having a combined width substantially equal to the width of the bottom of the hopper.

6. A bulk product feeding system in accordance with claim 5, further comprising a back end of the hopper and a second outlet located at the bottom of the back end, wherein the two rams are configured to discharge product in opposite directions from the first and second outlets, respectively.

7. A bulk product feeding system in accordance with claim 5, further comprising a flexible finger gate, disposed at the outlet adjacent to each ram, having flexible fingers that downwardly extend into at least a portion of the outlet, to resist flow of bulk product therethrough.

8. A bulk product feeding system in accordance with claim 1, further comprising an oscillating finger gate, positioned to intercept product after discharge from the first outlet, having a plurality of substantially vertical, rigid fingers that extend into and agitate the product.

9. A bulk product feeding system in accordance with claim 8, wherein the oscillating finger gate is configured to oscillate at a rate of about 2-4 Hz.

10. A bulk product feeding system in accordance with claim 8, further comprising:
a downwardly oriented ramp, extending from the first outlet, the fingers of the oscillating finger gate extending to a position near a distal end of the ramp; and
a vertical drop, adjacent to the distal end of the ramp, whereby discharged product falls from the region of the oscillating finger gate to a product receiving structure.

11. A bulk product feeding system, comprising:
a product hopper, having a bottom, a front side, substantially vertical sidewalls defining a width, and an outlet located at the bottom of the front side, the hopper being configured to receive and hold a bulk quantity of sticky or fragile product, the sidewalls being spaced apart by a distance sufficient to resist bridging of the product;
a flexible finger gate, attached to the front side, having flexible fingers that downwardly extend into at least a portion of the outlet, to resist flow of bulk product therethrough; and
a ram, positioned in the bottom of the hopper and having a width substantially equal to the width of the hopper, configured to reciprocate to controllably discharge product through the outlet.

12. A bulk product feeding system in accordance with claim 11, wherein the ram comprises a stepped ram, having at least one step descending toward a forward end thereof.

13. A bulk product feeding system in accordance with claim 11, further wherein the ram comprises two rams, positioned side-by-side in the bottom of the hopper and configured to be independently reciprocally moveable therein, the two rams having a combined width substantially equal to the width of the bottom of the hopper.

14. A bulk product feeding system in accordance with claim 11, further comprising a pivoting gate, pivotally attached to the front side of the hopper and defining a top of the outlet, the flexible finger gate being attached at a lower end of the pivoting gate.

15. A bulk product feeding system in accordance with claim 11, further comprising an oscillating finger gate, positioned to intercept product after discharge from the outlet, having a plurality of substantially rigid fingers that extend into and agitate the product.

16. A bulk product feeding system, comprising:
a product hopper, having a bottom, a front side, substantially vertical sidewalls defining a width, and an outlet located at the bottom of the front side, the hopper being configured to receive and hold a bulk quantity of sticky or fragile product, the sidewalls being spaced apart by a distance sufficient to resist bridging of the product;
a ram, positioned in the bottom of the hopper and having a width substantially equal to the width of the hopper, configured to reciprocate to controllably discharge product through the outlet; and
an oscillating finger gate, positioned to intercept product after discharge from the outlet, having a plurality of substantially rigid fingers that extend into and agitate the product.

17. A bulk product feeding system in accordance with claim 16, wherein the ram comprises a stepped ram, having at least one step descending toward a forward end thereof.

18. A bulk product feeding system in accordance with claim 16, further wherein the ram comprises two rams, positioned side-by-side in the bottom of the hopper and configured to be independently reciprocally moveable therein, the two rams having a combined width substantially equal to the width of the bottom of the hopper.

19. A bulk product feeding system in accordance with claim 16, further comprising a pivoting gate, pivotally attached to the front side of the hopper and defining a top of the outlet, the flexible finger gate being attached at a lower end of the pivoting gate.

20. A bulk product feeding system in accordance with claim 16, further comprising a flexible finger gate, attached to the front side of the hopper, having flexible fingers that downwardly extend into at least a portion of the outlet, to resist flow of bulk product therethrough.

21. A method for controllably dispensing a bulk product, comprising the steps of:
placing a bulk quantity of the product into a hopper having a bottom, a front end, an outlet located in the bottom at the front end, and substantially vertical sidewalls defining a width sufficient to resist bridging of the product; and
reciprocating a stepped ram within the bottom of the hopper to dispense a controlled quantity through the outlet, the ram having at least one step descending toward a forward end thereof.

22. A method in accordance with claim 21, further comprising the step of measuring a product discharge quantity, and adjusting at least one of a speed and stroke length of the reciprocation of the ram in response to the discharge quantity.

23. A method in accordance with claim 21, further comprising the step of agitating the product, after discharge from the outlet, using an oscillating finger gate having a plurality of substantially rigid fingers that extend into the product.

24. A method in accordance with claim 21, further comprising the step of extending the ram a selected distance forward at a beginning of a stroke to compensate for compression of the product.

25. A method in accordance with claim 21, further comprising the step of moderating the product discharge with a flexible finger gate, comprising a plurality of flexible fingers extending downwardly at least partially into the outlet.

26. A method in accordance with claim 21, further comprising the steps of:
placing the product dispensed from the outlet into an inlet of a product measuring and dispensing machine; and
dispensing measured quantities of the product into product containers.
